(19) United States
(12) Patent Application Publication
(10) Pub. No.: US 2023/0158512 A1
(43) Pub. Date: May 25, 2023

(54) ULTRA LOW POWER ELECTRICAL DUST COLLECTION APPARATUS

(71) Applicant: KOREA INSTITUTE OF ENERGY RESEARCH, Daejeon (KR)

(72) Inventors: Yun Haeng JOE, Daejeon (KR); Hyun Seol PARK, Daejeon (KR); Ji Eun HEO, Wonju-si (KR); Dong Ho SHIN, Sejong-si (KR); Hee Joo CHO, Daejeon (KR); Joon Mok SHIM, Daejeon (KR)

(73) Assignee: KOREA INSTITUTE OF ENERGY RESEARCH, Daejeon (KR)

(21) Appl. No.: 17/988,465

(22) Filed: Nov. 16, 2022

(30) Foreign Application Priority Data
Nov. 23, 2021 (KR) 10-2021-0162339
Oct. 19, 2022 (KR) 10-2022-0135112

(51) Int. Cl. B03C 3/40; B03C 3/38; B03C 3/70; B03C 3/68; B03C 3/019; B03C 3/011

(52) U.S. Cl. CPC B03C 3/40; B03C 3/38; B03C 3/70; B03C 3/68; B03C 3/019; B03C 3/011

(57) ABSTRACT

According to an exemplary embodiment of the present disclosure, power is temporarily supplied to the basic dust collector and the first dielectric is charged with an electric charge, and then power supplying is stopped and dust-containing gas passes through a space between a plurality of basic dust collectors or a space between roll-type basic dust collectors to perform dust collection, and as a result, dust can be collected while the use of power supplied to a DC power supply unit from an external power supply is minimized, and further, dust collection efficiency can be increased by a concentration and distortion phenomenon at a portion where the first electrode forming a predetermined pattern is formed in the basic dust collector.

### CROSS-REFERENCE TO RELATED APPLICATIONS

This application claims the priority of Korean Patent Application Nos. 10-2021-0162339 filed on Nov. 23, 2021 and 10-2022-0135112 filed on Oct. 19, 2022, in the Korean Intellectual Property Office, the disclosure of which is incorporated herein by reference.

### BACKGROUND OF THE INVENTION

### Field of the Invention

The present disclosure relates to an electrical dust collection apparatus, and more particularly, to an ultra low power electrical dust collection apparatus that can minimize a use of external power by polarization of a dielectric substance.

### Description of the Related Art

An electric dust collection apparatus as an apparatus that electrically charges dust suspended in dust-containing gas using corona discharge and collects the charged dust by forming an electrical field between two dust collecting plates spaced apart at regular intervals is constituted by a dust collecting plate, a discharge electrode, and a power supply device, and is categorized into a single-stage electrical collection apparatus in which particle charging and dust collection are made in the same space and a two-stage electrical collection apparatus in which the particle charging and the dust collection are separated and made.

However, in the related art, in the two-stage electrical dust collection apparatus, high voltage should be continuously applied to the dust collecting plate by using the power supply device in order to form the electrical field between two duct collecting plates. In general, the power supply device used in the electrical collection apparatus uses a circuit constituted by a coil and multiple capacitors to boost several hundred volts to high voltage of several to several tens of kilovolts, and there is a problem in that power lost due to heat generated in an element in the circuit and power consumed by a cooling device are significant. Further, when the related art is applied to an environment in which a living space and the dust collecting plate communicate with each other through a dust-containing gas introduction passage, a user is continuously exposed to a safety accident due to high voltage, and when dust-containing gas under a high-moisture condition containing droplets is introduced into the dust collecting plate, it is impossible to form the electrical field between two dust collecting plates due to an electrical short by moisture, so there may be a problem in that dust collection performance is reduced.

### SUMMARY OF THE INVENTION

An object to be achieved by the present disclosure is to provide, as an ultra low power electrical dust collection apparatus as an apparatus that can charge an electrical energy by using a collector including a dielectric substance and capable of charging the electrical energy, and remove dust without power consumption in a state in which external power is interrupted by using the charged electrical energy, an ultra low power electrical dust collection apparatus which allows an electrode to form a predetermined pattern in the dust collector and induces a concentration and distortion phenomenon of an electrical field at a portion where the electrode is formed to remove dust by Coulomb's force and dielectrophoretic force.

An object to be achieved by the present disclosure is to provide, as an apparatus that is capable of removing dust by the Coulomb's force and the dielectrophoretic force, an ultra low power electric dust collection apparatus which can be easily manufactured and prevent pressure loss, and includes a dust collector capable of collecting a lot of dust with minimum power consumption.

An object to be achieved by the present disclosure is to provide an ultra low power electrical dust collection apparatus in which a surface of the dust collector including a dielectric substance and capable of charging the electrical energy is covered with an external insulator, and a plurality of protrusions is formed on the surface of the external insulator, and the concentration and distortion phenomenon is induced at a portion where the protrusion is formed to remove the dust by the Coulomb's force and the dielectrophoretic force.

An exemplary embodiment of the present disclosure provides an ultra low power electrical dust collection apparatus including: a housing including a dust collection space provided inside, an inlet through which dust-containing gas is introduced, and an outlet through gas from which dust is removed is released; a basic dust collector including a first dielectric substance positioned in the dust collection space, and having a first surface and a second surface facing each other, a conductive first electrode formed on the first surface, a conductive second electrode formed on the second surface, and an external insulator made of an insulator covering the first electrode and the second electrode; a DC power supply unit applying voltage to the basic dust collector so that an electrical potential is formed between the first electrode and the second electrode; a cut-off switch connected between the basic dust collector and the DC power supply unit; and a power supply control unit controlling power supplying to the DC power supply unit, in which the basic dust collector is provided with a plural number or configured in a roll form, the basic dust collector includes a first region portion in which an electrode is not formed on the first surface, and the first electrode and the first region portion are repeated along the first surface, and the power supplied to the DC power supply unit is interrupted and the cut-off switch is opened by the power supply control unit in a state in which the electrical potential is formed, and dust is removed from the dust-containing gas by an electrical field formed by polarization of the first dielectric substance due to the electrical potential.

The basic dust collector may include a second region portion in which the electrode is not formed on the second surface, and the second electrode and the second region portion may be repeated along the second surface.

The first electrode may be branched into multiple line segments, and at least some of respective line segments of the first electrode may be disposed in line with each other.

The first electrode may be branched into multiple line segments, and at least some of the respective line segments of the first electrode may be disposed in line with each other, and the second electrode may be branched into multiple line segments, and at least some of the respective line segments of the second electrode may be disposed in line with each other.

At least some of the branched line segment of the first electrode and the branched line segment of the second electrode may be configured to be parallel to each other, and the branched line segment of the first electrode and the branched line segment of the second electrode may be configured to be dislocated with each other, on a plan view.

The basic dust collector may include a conductive third electrode formed to be spaced apart from the first electrode on the first surface and a conductive fourth electrode formed to be spaced apart from the second electrode on the second surface, the external insulator may be configured to cover the third electrode and the fourth electrode, and the DC power supply unit may be configured to apply voltage to the basic dust collector so that the electrical potential is formed between the third electrode and the fourth electrode.

Each of the first electrode and the third electrode may be branched into multiple line segments, and at least some of the branched line segment of the first electrode and the branched line segment of the second electrode may be configured to be parallel to each other.

Each of the second electrode and the fourth electrode may be branched into multiple line segments, and at least some of the branched line segment of the second electrode and the branched line segment of the fourth electrode may be configured to be parallel to each other.

On the plan view, the branched line segment of the first electrode and the branched line segment of the second electrode may be configured to match each other, and the branched line segment of the third electrode and the branched line segment of the fourth electrode may be configured to match each other.

The first region portion may be a through-hole penetrating the first electrode.

The second region portion may be a through-hole penetrating the second electrode.

The external insulator may include a plurality of protrusions which protrudes to any one side or both sides.

Another exemplary embodiment of the present disclosure provides an ultra low power electrical dust collection apparatus including: a housing including a dust collection space provided inside, an inlet through which dust-containing gas is introduced, and an outlet through gas from which dust is removed is released; a basic dust collector including a first dielectric substance positioned in the dust collection space, and having a first surface and a second surface facing each other, a conductive first electrode formed on the first surface, a conductive second electrode formed on the second surface, and an external insulator made of an insulator covering the first electrode and the second electrode; a DC power supply unit applying voltage to the basic dust collector so that an electrical potential is formed between the first electrode and the second electrode; a cut-off switch connected between the basic dust collector and the DC power supply unit; and a power supply control unit controlling power supplying to the DC power supply unit, in which the basic dust collector is provided with a plural number or configured in a roll form, a plurality of first protrusions which protrudes on an outer surface of the external insulator is provided, and the power supplied to the DC power supply unit is interrupted and the cut-off switch is opened by the power supply control unit in a state in which the electrical potential is formed, and dust is removed from the dust-containing gas by an electrical field form.

The basic dust collector may include a 1-1^{st} surface which is a surface where the first electrode is formed and a 2-1^{st} surface which is a surface where the second electrode is formed, and the first protrusion may be formed in at least any one of the 1-1^{st} surface and the 2-1^{st} surface.

The first protrusion may be divided into a 1-1^{st} protrusion positioned at a portion where the first electrode is formed and a 1-2^{nd} protrusion positioned at a portion where the second electrode is formed, and the 1-1^{st} protrusion and the 1-2^{nd} protrusion may be disposed to be dislocated with each other on a plan view.

The ultra low power electrical dust collection apparatus may be configured to further include a filter disposed at the inlet or the outlet and removing the dust from the dust-containing gas.

The ultra low power electrical dust collection apparatus may be configured to further include a particle charging unit disposed at the inlet or the outlet, and ionizing the gas and electrically charging surrounding dust.

By an ultra low power electrical dust collection apparatus according to an exemplary embodiment of the present disclosure, a basic dust collector may include a first dielectric substance, a first electrode, a first region portion, a second electrode, and an external insulator, and the first electrode and the first region portion may be repeatedly formed on a first surface of the first dielectric substance. The first region portion may be a through-hole penetrating the first electrode. According to the exemplary embodiment of the present disclosure, power is temporarily supplied to the basic dust collector and the first dielectric substance is charged with an electrical energy, and then power supplying is stopped and dust-containing gas passes through a space between a plurality of basic dust collectors or a space between roll-type basic dust collectors to perform dust collection, and as a result, dust can be collected while the use of power supplied to a DC power supply unit from an external power supply is minimized, and further, dust collection efficiency can be increased by a concentration and distortion phenomenon at a portion where the first electrode forming a predetermined pattern is formed in the basic dust collector.

By the ultra low power electrical dust collection apparatus according to an exemplary embodiment of the present disclosure, the basic dust collector may further include a second region portion, and the second electrode and the second region portion may be formed on a second surface of the first dielectric substance. According to the exemplary embodiment of the present disclosure, each of the first electrode and the second electrode forms a predetermined pattern on the first surface and the second surface, and the dust collection efficiency of the dust can be further increased by the concentration and distortion phenomenon of the electrical field at portions where the first electrode and the second electrode are formed.

By the ultra low power electrical dust collection apparatus according to an exemplary embodiment of the present disclosure, the basic dust collector may be configured to further include a third electrode and a fourth electrode. According to the exemplary embodiment of the present disclosure, each of the first electrode and the second electrode forms a predetermined pattern on the first surface and the second surface, and the dust collection efficiency of the dust can be further increased by the concentration and distortion phenomenon of the electrical field at the portions where the first electrode and the second electrode are formed at portions where the third electrode and the fourth electrode are formed.

By the ultra low power electrical dust collection apparatus according to an exemplary embodiment of the present disclosure, the first electrode and/or the second electrode are formed in a predetermined pattern form in the basic dust collector to easily manufacture the basic dust collector.

By the ultra low power electrical dust collection apparatus according to an exemplary embodiment of the present disclosure, a plurality of first protrusion are provided on the surface of the external insulator to increase the dust collection efficiency of the dust by the collection and distortion phenomenon of the electrical field at a portion where the first protrusion is formed.

### BRIEF DESCRIPTION OF THE DRAWINGS

FIG. 1 is a diagram schematically illustrating an electrical dust collection apparatus according to an exemplary embodiment of the present disclosure.

FIGS. 2A, 2B and 2C are diagrams schematically illustrating an operation order of an electrical dust collection apparatus according to an exemplary embodiment of the present disclosure.

FIGS. 3A and 3B are diagrams illustrating an operation principle of the electrical dust collection apparatus according to an exemplary embodiment of the present disclosure.

FIG. 4 is a diagram illustrating a case where an additional DC power supply unit is installed in the electrical dust collection apparatus according to an exemplary embodiment of the present disclosure.

Each of FIGS. 5, 6, 7, 8, 9, and 10 schematically illustrates a basic dust collector according to an exemplary embodiment of the present disclosure.

FIGS. 11A and 11B are diagrams illustrating the operation principle of the electrical dust collection apparatus according to an exemplary embodiment of the present disclosure.

FIG. 12 is a diagram illustrating a state in which the additional DC power supply unit is further installed in the electrical dust collection apparatus according to FIGS. 11A and 11B.

Each of FIGS. 13A, 13B, 13C, 13D, and 13E is a diagram illustrating a schematic shape of the basic dust collector according to an exemplary embodiment of the present disclosure.

FIG. 14A is a diagram schematically illustrating the shape of the basic dust collector according to an exemplary embodiment of the present disclosure and FIG. 14B is a partial perspective view schematically illustrating a state of a second electrode formed at any one side of the basic dust collector according to an exemplary embodiment of the present disclosure.

Each of FIGS. 15A, 15B, and 15C is a diagram schematically illustrating the basic dust collector according to an exemplary embodiment of the present disclosure.

Each of FIGS. 16A, 16B, 16C, 16D, and 16E is a diagram illustrating a state in which the basic dust collector is arranged.

Each of FIGS. 17 and 18 is a diagram illustrating a schematic shape of the basic dust collector in the electrical dust collection apparatus according to an exemplary embodiment of the present disclosure.

FIG. 19 is a diagram schematically illustrating a state in which a filter is provided in a housing of the electrical dust collection apparatus according to an exemplary embodiment of the present disclosure.

Each of FIGS. 20A and 20B is a diagram schematically illustrating a state in which a particle charging unit is provided in the electrical dust collection apparatus according to an exemplary embodiment of the present disclosure.

FIGS. 21A and 21B are diagrams schematically illustrating a state in which a terminal connected to an electrode is formed in the basic dust collector according to an exemplary embodiment of the present disclosure.

Each of FIGS. 22 and 23 is a diagram schematically illustrating a state in which an external insulator is laminated in the basic dust collector.

### DETAILED DESCRIPTION OF THE PREFERRED EMBODIMENT

Hereinafter, exemplary embodiments of the present disclosure will be described in detail with reference to accompanying drawings, and the same or similar elements are designated with the same numeral references regardless of numerals in the drawings and their redundant description will be omitted. As used herein, the terms “module” and “unit” used to refer to components are used interchangeably in consideration of convenience of explanation, and thus, the terms per se should not be considered as having different meanings or functions. In relation to describing the present disclosure, when the detailed description of the relevant known technology is determined to unnecessarily obscure the gist of the present disclosure, the detailed description can be omitted. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

Although the terms first, second, third, and the like can be used herein to describe various elements, components, regions, layers, and/or sections, these elements, components, regions, layers, and/or sections should not be limited by these terms. These terms are generally only used to distinguish one element from another.

When an element or layer is referred to as being “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to,” or “directly coupled to” another element or layer, there can be no intervening elements or layers present.

As used herein, the articles “a,” “an,” and “the,” include plural referents unless the context clearly dictates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

In each drawing for describing an ultra low power electrical dust collection apparatus (hereinafter, referred to as ‘electrical dust collection apparatus 1’) according to an exemplary embodiment of the present disclosure, a switch is displayed inside a power supply control unit 240, and this is just for understanding on/off, and does not represent a separate configuration.

The electrical dust collection apparatus 1 according to an exemplary embodiment of the present disclosure may be configured to include a basic dust collector 130.

Hereinafter, the electrical dust collection apparatus 1 according to an exemplary embodiment of the present disclosure will be described.

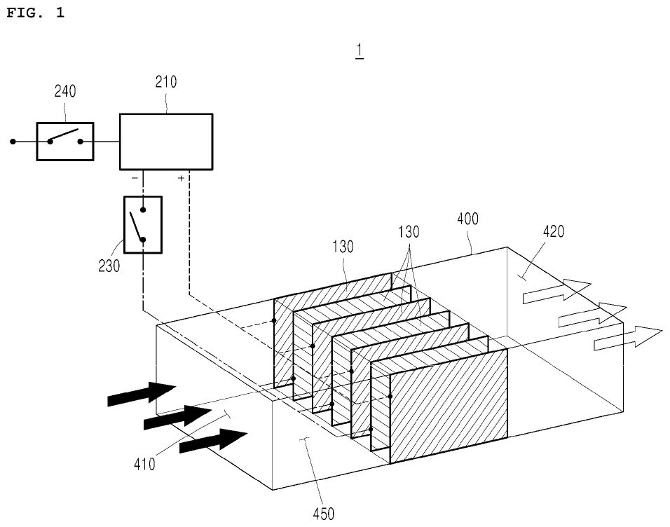

FIG. 1 is a diagram schematically illustrating an electrical dust collection apparatus 1 according to an exemplary embodiment of the present disclosure.

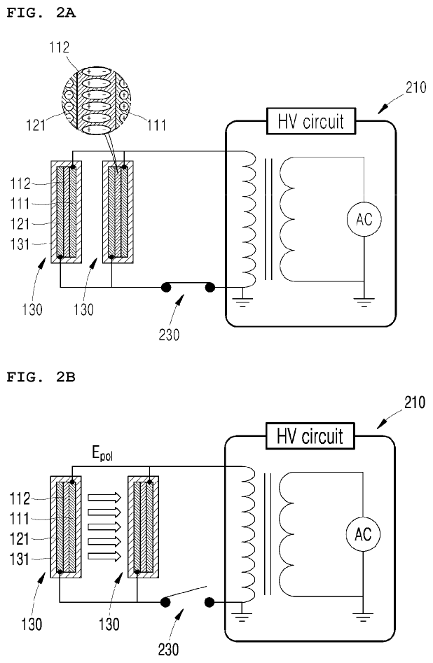

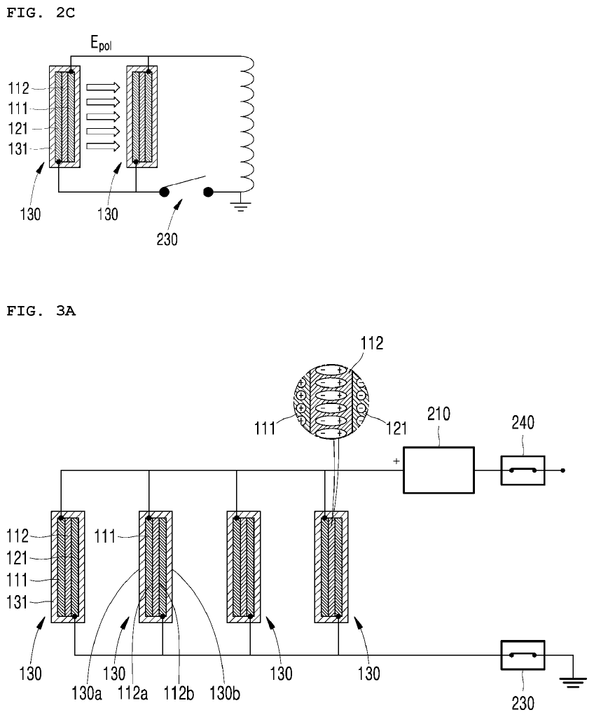

FIGS. 2A, 2B and 2C are diagrams schematically illustrating an operation order of an electrical dust collection apparatus 1 according to an exemplary embodiment of the present disclosure.

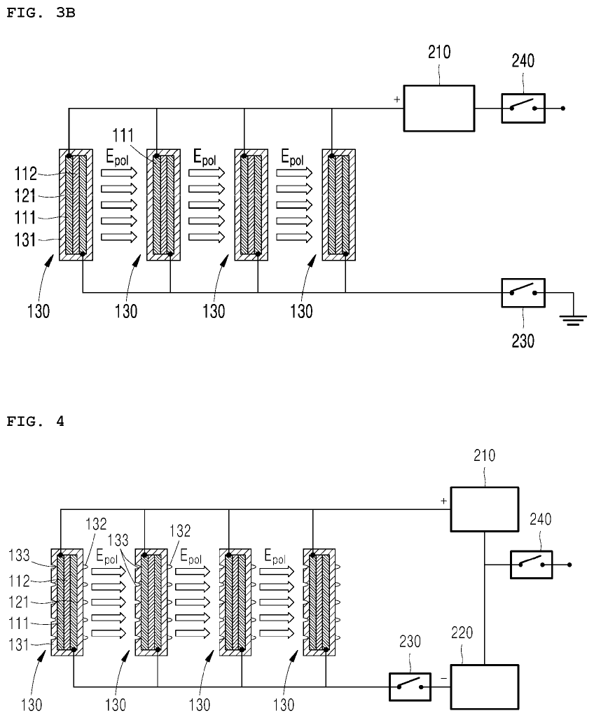

FIGS. 3A and 3B are diagrams illustrating an operation principle of the electrical dust collection apparatus 1 according to an exemplary embodiment of the present disclosure.

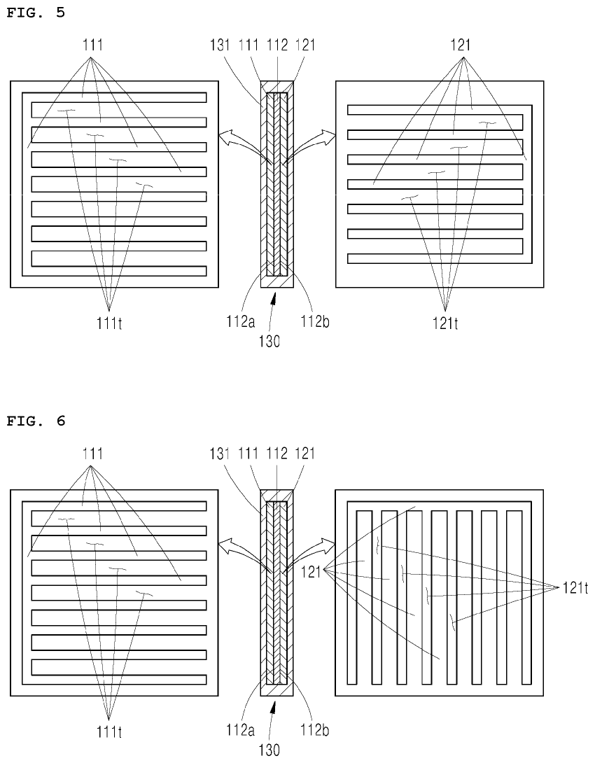

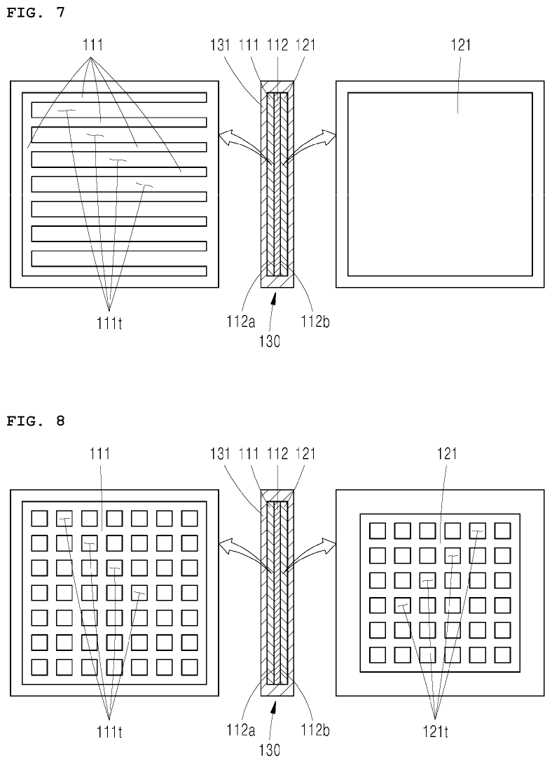

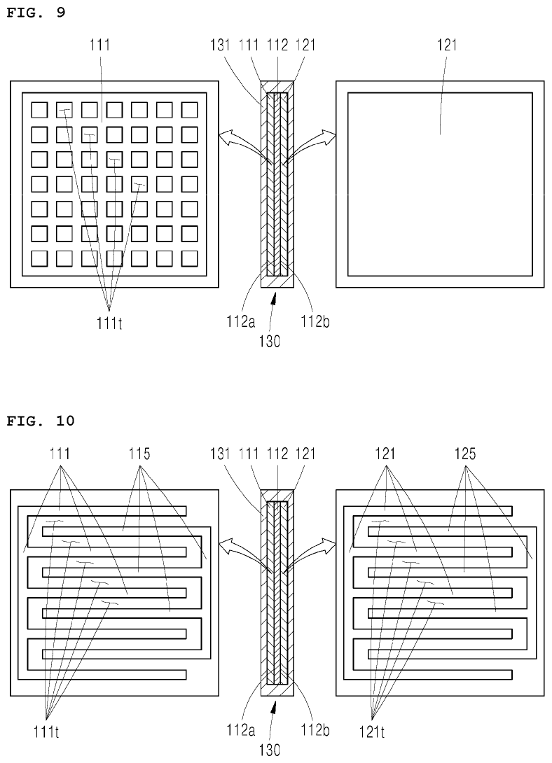

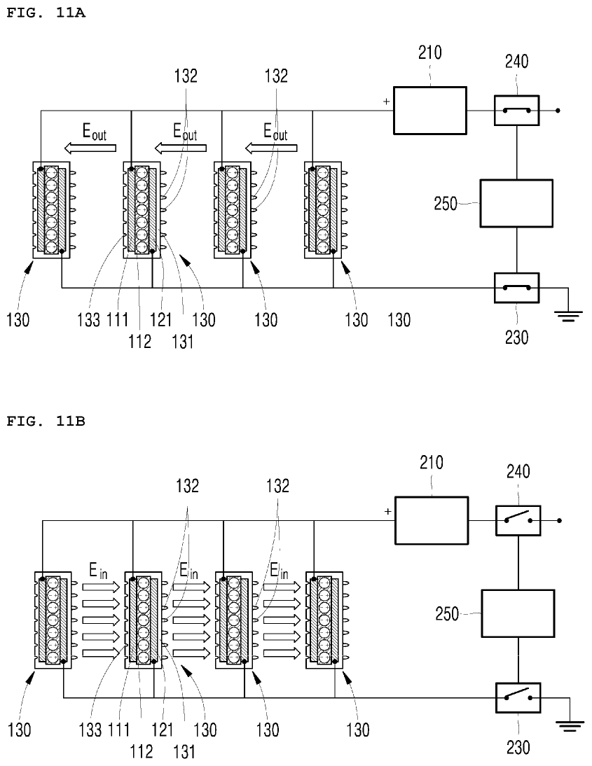

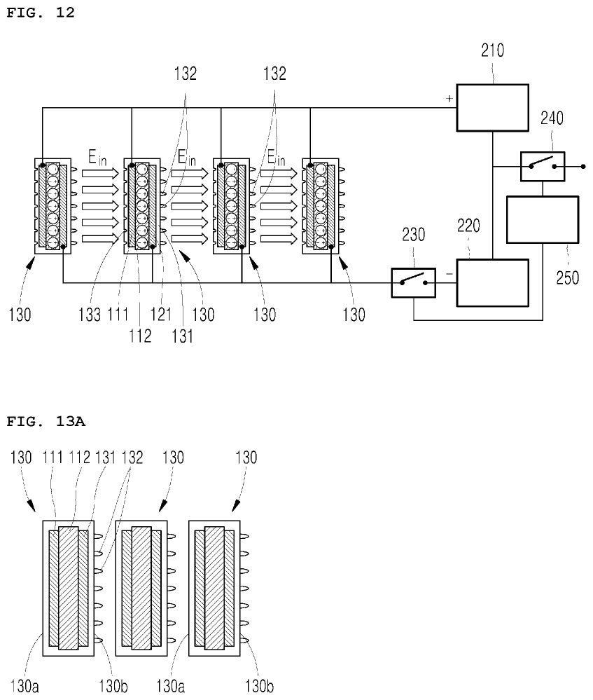

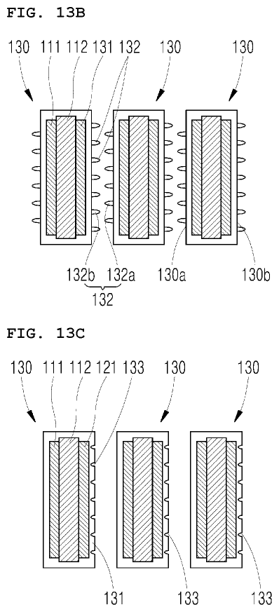

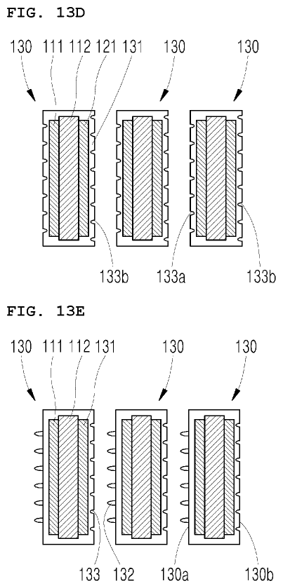

In addition, FIG. 4 is a diagram illustrating a case where an additional DC power supply unit 220 is installed in the electrical dust collection apparatus 1 according to an exemplary embodiment of the present disclosure.

As illustrated in FIGS. 1 to 3B, the electrical dust collection apparatus 1 includes a housing 400, a basic dust collector 130, a DC power supply unit 210, a cut-off switch 230, and a power supply control unit 240.

The housing 400 may form an overall appearance of the electrical dust collection apparatus 1. The housing 400 includes a dust collection space 450 forming an internal space thereof. Further, the housing 400 may be configured to include an inlet 410 though which dust-containing gas is introduced and an outlet 420 through which gas from which dust is removed is released. The dust-containing gas may be introduced into the housing 400 through the inlet, the dust may be removed from the dust collection space 450, and then clean gas may be released to the outside of the housing 400 through the outlet 420.

The basic dust collector 130 is positioned in the dust collection space 450 of the housing 400, and is configured to include a first dielectric substance 112, a first electrode 111, a second electrode 121, and an external insulator 131. Each of the first dielectric substance 112, the first electrode 111, the second electrode 121, and the external insulator 131 forms a layer, and the first dielectric substance 112, the first electrode 111, the second electrode 121, and the external insulator 131 may form the basic dust collector 130 while being stacked and coupled to each other.

The basic dust collector according to an exemplary embodiment of the present disclosure is formed in a capacitor structure.

The basic dust collector 130 may be formed in a plate or film form having a predetermined area.

The first dielectric substance 112 is made of a material (a dielectric substance) which is polarized by an external power supply to charge an electric charge. The first dielectric substance 112 may be formed in the film form. The first dielectric substance 112 includes a first surface 112a and a second surface 112b. The first surface 112a and the second surface 112b form opposite surfaces to each other in the first dielectric substance 112.

‘First’ of the ‘first dielectric substance’ described in the exemplary embodiment of the present disclosure is used for distinguishing the ‘first dielectric substance’ from a general ‘dielectric substance’. The ‘first dielectric substance’ described in the exemplary embodiment of the present disclosure as a dielectric substance constituting the ‘basic dust collector’ may mean a dielectric substance provided between two electrodes corresponding to each other, and may be referred to as the ‘dielectric substance’.

Each of the first electrode 111 and the second electrode 121 is made of a conductive substance. The first electrode 111 and the second electrode 121 are formed at opposite side to each other around the first dielectric substance 112. When the first electrode 111 is formed on the first surface 112a of the first dielectric substance 112, the second electrode 121 is formed on the second surface 112b of the first dielectric substance 112. Positive voltage may be applied to any one of the first electrode 111 and the second electrode 121, and the other one may be grounded.

The external insulator 131 is made of an insulator, and covers the first electrode 111 and the second electrode 121 and forms an outer surface of the basic dust collector. The external insulator 131 may be formed in the film form. In the basic dust collector 130, the external insulator 131 may be formed by coating (laminating). The external insulator 131 may be made of the same substance as the first dielectric substance 112, but is not limited thereto.

The DC power supply unit 210 forms an electrical potential in the first surface 112a and the second surface 112b of the first dielectric substance 112 and polarizes the first dielectric substance 112.

The power supply control unit 240 controls power supplying to the DC power supply unit 210.

The cut-off switch 230 is electrically connected between the basic dust collector 130 and the DC power supply unit 210. In an exemplary embodiment, the cut-off switch 230 may be electrically positioned between the first electrode 111 and the DC power supply unit 210. In another exemplary embodiment, the cut-off switch 230 may be electrically positioned between the grounded second electrode 121 and a ground.

In a state in which a plurality of respective basic dust collectors 130 are positioned to be spaced apart from each other, and the power supplying to the DC power supply unit 210 is cut off by the power supply control unit 240, the dust-containing gas introduced into the inlet 410 of the housing 400 may pass through a space in which the basic dust collectors 130 are space apart from each other, and the dust in the dust-containing gas may be removed.

As described above, the first dielectric substance 112, the first electrode 111, the second electrode 121, and the external insulator 131 may be provided in one basic dust collector 130, and the first dielectric substance 112 may be formed between the first electrode 111 and the second 121, and the external insulator 131 may form the outer surface of the basic dust collector 130 while surrounding the first electrode 111 and the second electrode 121. A plurality of basic dust collectors 130 may be formed in one housing 400, and respective basic dust collectors 130 are spaced apart from each other, and the space may be formed between the respective basic dust collectors 130. The respective basic dust collectors may be arranged in line with each other.

The power supply control unit 240 may be configured to control power supplying to the DC power supply unit 210 so that a power supply time t1 which is a time of supplying the power to the DC power supply unit 210 in a state which the cut-off switch 230 is closed is shorter than a power cut-off time t2 which is a time of cutting off the power supplied to the DC power supply unit, and a power use amount of the electrical dust collection apparatus 1 may be reduced as a ratio of the power cut-off time t2 to the power supply time t1 increases.

According to the exemplary embodiment of the present disclosure, even when the power is temporarily applied to the DC power supply unit 210 by the power supply control unit 240, and then cut off, an electrical field E_{Pol} is formed between the first electrode 111 and the second electrode 121 positioned to be adjacent to each other and to face each other by polarization of the first dielectric substance 112 to remove the dust in the dust-containing gas passing through the dust collection space 450.

Here, the time (power supply time t1) for which the DC power supply unit 210 applies the power to the first electrode 111 or the second electrode 121 in the state in which the cut-off switch 230 is closed may be progressed for several milliseconds to several seconds, and the power cut-off time t2 may be progressed for tens of minutes to several hours in the state in which the cut-off switch is opened. In addition, according to an exemplary embodiment of the present disclosure, the dust may be removed from the dust-containing gas by the electrical field E_{Pol} formed by the polarization the first dielectric substance 112 for the power cut-off time t2. That is, after the power cut-off of the DC power supply unit 210, the dust may be removed from the dust-containing gas by the electrical field E_{Pol} formed by the polarization the first dielectric substance 112 and maintained for tens of minutes to several hours. A principle thereof will be described below.

FIGS. 2A and 3A are diagrams for a case where the cut-off switch 23 is closed and the power is supplied to the DC power supply unit 210, and an electrical potential is formed on the first surface 112a and the second surface 112b of the first dielectric substance 112, and FIG. 2B is a diagram for a case where the cut-off switch 230 is opened, and FIGS. 2C and 3B are diagrams for a case where the cut-off switch 230 is opened, the power supplying to the DC power supply unit 210 is cut off and the electric E_{Pol} is formed between two basic dust collectors 130 by they polarization of the first dielectric substance 112.

First, as illustrated in FIGS. 2A and 3A, when the positive voltage is applied to the first electrode 111 by the DC power supply unit 210, and the cut-switch 230 is closed and the second electrode 121 is grounded, the electrical potential is generated between the first electrode 111 and the second electrode 121 positioned to face each other, and as a result, the first dielectric substance 112 may be polarized. In this case, in the exemplary embodiment of the present disclosure, the electrical field formed between the first electrode 111 and the second electrode 121 of two basic dust collectors 130 may be referred to as an external electrical field Eₒᵤₜ.

Meanwhile, in this case, as illustrated in FIG. 2B, the cut-off switch 230 may be opened.

Next, as illustrated in FIGS. 2C and 3B, the cut-off switch 230 may be opened and the voltage applied to the first electrode from the DC power supply unit 210 may be cut off by the power supply control unit 240. The opening of the cut-off switch 230 and the cut-off of the power supplying by the power supply control unit 240 may be performed simultaneously with each other or nay one may be performed before the other one.

When the voltage applied to the first electrode 111 is cut off by the power supply control unit 240 after the cut-off switch 230 is opened, a closed circuit in which the DC power supply unit 210, the basic dust collector 130, and the ground are connected in order becomes an open circuit by the opened cut-off switch 230.

In a general high-voltage generation apparatus, when the power is cut off, a high voltage outlet is grounded, and the electrical potential inside an apparatus connected to the high voltage outlet disappears. However, as illustrated in FIG. 2B, in a structure in which the cut-off switch 230 is opened, even though the high voltage outlet is grounded (the power is cut off), an electric charge stored in the first dielectric substance 112 may be retained by the opened cut-off switch 230. As a result, the electrical field E_{Pol} (in this case, the electrical field E_{Pol} may be referred to as an internal electrical field Eᵢₙ) generated between two basic dust collectors 130 positioned to face each other may be retrained for a long time even though the external power supply is cut off, and the dust in the dust-containing gas introduced between two basic dust collectors 130 may be collected by the electrical field E_{Pol} formed by the polarization of the first dielectric distance 112.

Meanwhile, the intensity of the electrical field E_{Pol} formed by the polarization of the first dielectric substance 112 may be spontaneously reduced (self-discharged) over time, or reduced as the dust is collected by the basic dust collector 130.

When the positive voltage is applied to the first electrode 111 and the second electrode 121 is grounded, the electrical field E_{Pol} formed by the polarization of the first dielectric substance 112 is formed in the direction of the first electrode 111 from the second electrode 121, and positive charged dust among the dust introduced into the electrical dust collection apparatus 1 moves to the first electrode 111 to be collected and negative charged dust moves to the second electrode 121 to be collected. In this case, an electrical field in an opposite direction to the electrical field E_{Pol} formed by the polarization of the first dielectric substance 112 is generated between the positive charged dust collected by the first electrode 111 and the negative charged dust collected by the second electrode 121 to reduce a net electrical field strength between two basic dust collectors 130. As a result, a dust collection performance of the electrical dust collection apparatus 1 may be reduced as the dust is accumulated on the surface of the basic dust collector 130.

However, an electric charge amount of the dust in the dust-containing gas which does not go through a separate charging process is even smaller than the electric charge amount accumulated by the polarization of the first dielectric substance 112. Therefore, the intensity of the electrical field E_{Pol} generated by the polarization of the first dielectric substance 112 is even larger than the intensity of the electric field generated due to the collected dust, and for this reason, even though the dust is collected on the surface (the surface of the external insulator 131) of the basic dust collector 130, the electrical field E_{Pol} formed by the polarization of the first dielectric substance 112 may be retained for several hours. As a result, in a state in which the power of the DC power supply unit 210 is cut off for a long time, the dust in the dust-containing gas introduced between the basic dust collectors may be stably collected.

A time for which the dielectric substance is charged with the power and a dielectric substance discharge time due dust attachment may be calculated a general resistance-capacitance (R-C) circuit interpretation. Theoretically, a time of a millisecond level may be required for charging the dielectric substance with high voltage of several kV under a general power usage condition, and the electrical field generated by the electric charge charged in the dielectric substance may be retained for tens of hours even under a condition in which the discharge is made due to collection of high voltage charged particles.

Further, since the power of the DC power supply unit 210 is cut off while the collection is performed, voltage drop by an electrical short generated upon dust-containing gas processing under a high moisture condition containing moisture and droplets and an overcurrent flow phenomenon form the DC power supply unit 210 may be prevented to enable the high moisture dust=containing processing, and an electrical safety accident may be prevented.

In the electrical dust collection apparatus 1 according to an exemplary embodiment of the present disclosure, the basic dust collector 130 is configured to include the external insulator 131.

Unlike the exemplary embodiment of the present disclosure, when two adjacent basic dust collector 130 do not include the external insulator 131, the first electrode 111 and the second electrode 121 positioned to face each other are electrically insulated by the dust-containing gas in a separation space, so the electrical field generated between the first electrode 111 and the second electrode 121 may not exceed a dielectric strength of the dust-containing gas. However, when the basic dust collector 130 includes the external insulator 131 and the external insulator 131 surrounds the first electrode 111 and the second electrode 121, insulation between the first electrode and the second electrode 121, so a higher electrical field may be stably formed.

As illustrated in FIG. 4, the electrical dust collection apparatus 1 according to an exemplary embodiment of the present disclosure may include an additional DC power supply unit 220 supplying power having an electrical potential from the first electrode 111 to the second electrode 121.

The additional DC power supply unit 220 may be implemented by installing a separate power supply unit or splitting an output voltage wire (or electrode) of the DC power supply unit 210 into a plurality of output voltage wires, and then connecting an integrated circuit (IC), a resistance element, etc., to some of the plurality of output voltage wires to change an intensity or a polarity of voltage output from the DC power supply unit 210.

When the additional DC power supply unit 220 is installed as described above, the cut-off switch 230 may be positioned between the second electrode 121 and the additional DC power supply unit 220, and the powers of the DC power supply unit 210 and the additional DC power supply unit 220 may be individually or simultaneously controlled by one or a plurality of power supply control units 240.

In an exemplary embodiment, as illustrated in FIG. 4, the DC power supply unit 210 and the additional DC power supply unit 220 are connected and interlocked to one power supply control unit 240 to be controlled.

Alternatively, unlike illustrated in FIG. 4, the electrical dust collection apparatus 1 may be configured to include two power supply control units (a first power supply control unit a second power supply control unit). In this case, the first power supply control unit a second power supply control unit may be operated in link with each other.

When the first dielectric substance 112 is polarized by using the DC power supply unit 210 and the additional DC power supply unit 220 as compared with the case of polarizing the first dielectric substance 112 by using the DC power supply unit 210, the use time of the DC power supply unit 210 and the additional DC power supply unit 220 may be further reduced by accelerating the polarization of the first dielectric substance 112, and as a result, power required for operating the electrical dust collection apparatus 1 may be further reduced.

Each of FIGS. 5, 6, 7, 8, 9, and 10 schematically illustrates the basic dust collector 130 according to an exemplary embodiment of the present disclosure. In each of FIGS. 5 to 10, a state of the electrode formed on the first surface 112a of the first dielectric substance 112 is schematically illustrated at a left side of the basic dust collector 130 having a cross-sectional shape, and a state of the electrode formed on the second surface 112b of the first dielectric substance 112 is schematically illustrated at a right side.

In the electrical dust collection apparatus 1 according to an exemplary embodiment of the present disclosure, the basic dust collector 130 is configured to include a first region portion lilt. The first region portion lilt is a portion corresponding to a region in which the electrode is not formed on the first surface 112a of the first dielectric substance 112. Therefore, the first dielectric substance 112 and the external insulator 131 may be in direct contact with each other at the first region portion lilt of the first surface 112a.

In the electrical dust collection apparatus 1 according to an exemplary embodiment of the present disclosure, the basic dust collector 130 is configured to include a second region portion 121t. The first region portion 121t is a portion corresponding to a region in which the electrode is not formed on the second surface 112b of the first dielectric substance 112. Therefore, the first dielectric substance 112 and the external insulator 131 may be in direct contact with each other at the second region portion 121t of the second surface 112b.

In the first surface 112a of the first dielectric substance 112, the first electrode 111 may be configured in various pattern forms. That is, in the first surface 112a of the first dielectric substance 112, the first electrode 111 may be configured by a combination of a series of straight lines and/or curved lines.

In the first surface 112a of the first dielectric substance 112, the first electrode 111 and the first region portion 111t may be repeatedly formed each other along the first surface 112a of the first dielectric substance 112.

Each of the first electrode 111 and the first region portion lilt may be configured in the form of a plurality of line segments, and the line segment of the first electrode 111 and the line segment of the first region portion lilt may be repeated in a plane direction of the first surface 112a of the first dielectric substance 112 in the first surface 112a of the first dielectric substance 112.

The first electrode 111 may be configured to be branched into multiple line segments. At least some of respective line segments of the first electrode may be arranged in line with each other. The respective line segments of the first electrode may be arranged to be parallel to a horizontal direction or arranged to be parallel to a vertical direction.

The first electrode 111 may be divided into the plurality of line segments, and the respective line segments may be configured to be orthogonal or to cross. The first electrode 111 may be configured in a grid form. As a result, the first region portion 111t may be repeatedly formed while constituting a row and a column in the first surface 112a of the first dielectric substance 112.

In the second surface 112b of the first dielectric substance 112, the second electrode 121 may be configured in various pattern forms. That is, in the second surface 112b of the first dielectric substance 112, the second electrode 121 may be configured by a combination of a series of straight lines and/or curved lines.

In the second surface 112b of the first dielectric substance 112, the second electrode 121 and the second region portion 121t may be repeatedly formed each other along the second surface 112b.

Each of the second electrode 121 and the second region portion 121t may be configured in the form of the plurality of line segments, and the line segment of the second electrode 121 and the line segment of the second region portion 121t may be repeated in the plane direction of the second surface 112b in the second surface 112b of the first dielectric substance 112. The second electrode 121 may be configured to be branched into multiple line segments. At least some of respective line segments of the second electrode may be arranged in line with each other. The respective line segments of the second electrode may be arranged to be parallel to the horizontal direction or arranged to be parallel to the vertical direction.

The second electrode 121 may be divided into the plurality of line segments, and the respective line segments may be configured to be orthogonal or to cross. The second electrode 121 may be configured in the grid form. As a result, the second region portion 121t may be repeatedly formed while constituting the row and the column in the second surface 112b of the first dielectric substance 112.

At least some of the branched line segment of the first electrode 111 and the branched line segment of the second electrode 121 may be configured to be parallel to each other.

In the basic dust collector 130 according to an exemplary embodiment of the present disclosure, the branched line segment of the first electrode 111 and the branched line segment of the second electrode 121 may be configured to be dislocated with each other, on the plan view.

In the basic dust collector 130 according to an exemplary embodiment of the present disclosure, the branched line segment of the first electrode 111 and the branched line segment of the second electrode 121 may be configured to be orthogonal to or cross each other.

The external insulator 131 may be configured to be connected to the first dielectric substance 112 through the first region portion lilt in the first surface 112a of the first dielectric substance 112.

The external insulator 131 may be configured to be connected to the first dielectric substance 112 through the second region portion 121t in the second surface 112b of the first dielectric substance 112.

In an exemplary embodiment, an external surface of the external insulator 131 may be configured to be flat.

In another exemplary embodiment, the external insulator 131 may be configured in a form in which a protrusion 131 and/a groove 133 are repeated on the outer surface.

In the electrical dust collection apparatus 1 according to an exemplary embodiment of the present disclosure, the first electrode 111 and the first region portion lilt are repeatedly formed in the first surface 112a of the first dielectric substance 112 of the basic dust collector 130, and the second electrode 121 and the second region portion 121t are repeatedly formed in the second surface 112b of the first dielectric substance 112, and as a result, the electrical field E_{Pol} generated between the basic dust collectors 130 is concentrated and distorted to increase dust collection efficiency for the dust in the dust-containing gas.

That is, when the electrical field E_{Pol} is generated between the basic dust collectors 130 by the polarization of the first dielectric substance 112, a stronger electrical field may be generated at a point where the first region portion lilt is formed than at a point where the first region portion lilt is formed, and a stronger electrical field may be generated at a point where the second electrode 121 is formed than at a point where the second region portion 121t is formed. The electrical field E_{Pol} between two basic dust collectors 130 is concentrated on a portion where the first electrode 111 is formed and at a portion where the second electrode 121 is formed, and the intensity of the electrical field varies depending on the location and develops non-uniformly.

The electrical dust collection apparatus 1 according to an exemplary embodiment of the present disclosure is configured to collect dust by using the Coulomb's force and the dielectrophoretic force.

The Coulomb's force is force expressed as [Equation 1] below.

F=qE [Equation 1]

In [Equation 1] above, q represents a charge amount which dust to be processed has and E represents the intensity of the electrical field formed between two basic dust collectors 130.

As known as in [Equation 1] above, when the dust is intended to be collected only by the Coulomb's force, all dust may not be collected, and it is possible to collect only dust (not caught in the case of q=0) of at least q≥1 or more.

However, since dust suspended at the atmosphere (or in a room) follows a Boltzman charge distribution which is a normal distribution in which an average is 0) and is electrically neutralized, the dust may not be effectively collected if a separate charge device (a device which grants q to a particle) is not installed at a front end of the electrical dust collection apparatus 1.

On the contrary, the dielectrophoretic force is expressed as [Equation 2] below.

F=2πr³εₘRe[K]∇E² [Equation 2]

In [Equation 2] above, r represents a radius of a particle to be processed, εₘ represents a dielectric constant of the dust-containing gas, represents a real number value of a Clasius-Mossotti constant expressed as a complex number, and E represents an electrical field intensity between two basic dust collectors 130.

As shown in [Equation 2] above, the dielectrophoretic force is force applied even to a non-charged particle (q=0), and is a function for a gradient of the electrical field formed between two basic dust collectors 130.

That is, in order to use the dielectrophoretic force, the electrical field between two basic dust collectors 130 should be spatially distorted and when the dielectrophoretic force is used, it is possible to collect the non-charged particle.

When the protrusion 132 and/or the groove 133 are/is formed on the outer surface of the basic dust collector 130 or the first electrode 111 and/or the second electrode 121 are/is configured in the predetermined pattern form as described above, the electrical field which is distorted is basically formed between two basic dust collectors 130 facing each other, so the non-charged (q=0) may be collected by the dielectrophoretic force, and the dust collection performance may be further increased because the charged (q≠0) is simultaneously influenced by the Coulomb's force and the dielectrophoretic force.

In the exemplary embodiment of the present disclosure, the first electrode 111 and the first region portion lilt are repeatedly formed in the first surface 112a of the first dielectric substance 112 to induce the concentration and distortion phenomenon of the electrical field E_{Pol} formed between two basic dust collectors 130. Further, the second electrode 121 and the second region portion 121t are repeatedly formed in the second surface 112b of the first dielectric substance 112 to induce the concentration and distortion phenomenon of the electrical field E_{Pol} formed between two basic dust collectors 130.

That is, the electrical field may be formed at the point where the first region portion lilt is formed more strongly than at the point where the first electrode 111 is formed in the first surface 112a of the first dielectric substance 112, and the electrical field may be formed at the point where the second region portion 121t is formed than at the point where the second electrode 121 is formed in the second surface 112b of the first dielectric substance 112. Further, since the electrical field is strongly distorted at an edge portion (edge effect), the dielectrophoretic force may also be maximized at an edge at which the first electrode 111 contacts the first region portion lilt and an edge at which the second electrode 121 contacts the second region portion 121t due to a strong electrical field distortion effect.

As described above the first electrode 111 or the second electrode 121 formed in two basic dust collectors 130 positioned to face each other induces the concentration and distortion of the electrical field E_{Pol} to enhance the dust collection performance, and in this case, a dislocation arrangement of the first electrode 111 and the second electrode 121 positioned to face each other makes the electrical field be non-uniformly formed frequently in the dust collection space 450 to further enhance the dust collection performance.

Meanwhile, the electrical field E_{Pol} non-uniformly developed by the first electrode 111 and the second electrode 121 is retained even in the state in which the power of the DC power supply unit 210 is cut off, the power consumption may be minimized and dust collection in the dust-containing gas may be effectively achieved.

Hereinabove, all of the first electrode 111, the first region portion lilt, the second electrode 121, and the second region portion 121t described above are utilized as physical devices that induce the concentration and distortion phenomenon of the electrical field E_{Pol} developed in two adjacent basic dust collectors 130, and the dust collection performance suing the dielectrophoretic force may be enhanced through the utilized physical device.

The form of the first electrode formed on the first surface 112a of the first dielectric substance 112 and the form of the second electrode formed on the second surface 112b of the first dielectric substance 112 may be made by various combinations with each other, of course.

When the first electrode 111 and/or the second electrode 121 are configured in the predetermined pattern form, there is the following advantage.

In the exemplary embodiment of the present disclosure, forming of the electrode pattern in the first surface 112a of the first dielectric substance 112 (repeated forming of the first electrode 111 and the first region portion lilt) and forming of the electrode pattern in the second surface 112b of the first dielectric substance 112 (repeated forming of the second electrode 121 and the second region portion 121t) are relatively very easy processes because the electrode is printed by using a mask having a predetermined shape when the electrode is applied to both surfaces (the first surface 112a and the second surface 112b) of the first dielectric substance), and as a result, product processing continuity and economics may be secured.

Meanwhile, the electrical dust collection apparatus 1 is a structure through which a fluid passes, and all fluids pass through the electrical dust collection apparatus 1, and pressure loss is generated.

Since an increase in pressure loss exerts a bad influence such as a load increase of an entire system, and an increase in noise, heat dissipation, vibration, and power consumption, goals of all dust collection facilities are to maintain high dust collection efficiency in low pressure loss.

When the electrode pattern is formed in the basic dust collector 130 as described above, the surface (the surface of the external insulator 131) of the basic dust collector 130 is smooth, so the dust collection efficiency may be enhanced due to the distortion of the electrical field without causing the pressure loss.

How much the dust may be collected for a predetermined time is expressed as a clean air delivery rate (CADR) which is a multiplication of a flow rate and the dust collection efficiency. That is, even a device having the same dust collection efficiency may collect more dust for a predetermined time as the flow rate is higher.

As in the exemplary embodiment of the present disclosure, when the electrode pattern is formed in the basic dust collector 130, the pressure loss may be prevented, so a dust amount which may be collected for a predetermined is relatively larger.

In the electrical dust collection apparatus 1 according to an exemplary embodiment of the present disclosure, the basic dust collector 130 may be configured to include a third electrode 115. Further, the basic dust collector 130 may be configured to include a fourth electrode 125.

Each of the third electrode 115 and the fourth electrode 125 is made of a conductive material. The third electrode 115 is formed on the first surface 112a of the first dielectric substance 112 and the fourth electrode 125 is formed on the second surface 112b of the first dielectric substance 112.

The third electrode 115 may be formed by the same method as the first electrode 111. The third electrode 115 may be formed at the same time as the first electrode 111 at the time of manufacturing the basic dust collector 130. The fourth electrode 125 may be formed by the same method as the second electrode 121. The fourth electrode 125 may be formed at the same time as the second electrode 121 at the time of manufacturing the basic dust collector 130.

The third electrode 115 is spaced apart from the first electrode 111 in the first surface 112a of the first dielectric substance 112. The fourth electrode 125 is spaced apart from the second electrode 121 in the second surface 112b of the first dielectric substance 112.

In the basic dust collector 130, the external insulator 131 is configured to cover the third electrode 115 and the fourth electrode 125.

The DC power supply unit 210 is configured to apply voltage to the basic dust collector 130 so that the electrical potential is formed between the first electrode 111 and the third electrode 115, between the second electrode 121 and the fourth electrode 125, between the first electrode 111 and the second electrode 121, and between the third electrode 115 and the fourth electrode 125.

To this end, the third electrode 115 may be electrically connected to the second electrode 121, and the fourth electrode 125 may be electrically connected to the first electrode 111.

The first electrode 111 and the fourth electrode 125 may be electrically connected to each other continuously or selectively. The second electrode 121 and the third electrode 115 may be electrically connected to each other continuously or selectively.

When the additional DC power supply unit 220 is provided, the DC power supply unit 210 and the additional DC power supply unit 220 are configured to apply the voltage to the basic dust collector 130 so that the electrical potential is formed between the first electrode 111 and the third electrode 115, between the second electrode 121 and the fourth electrode 125, between the first electrode 111 and the second electrode 121, and between the third electrode 115 and the fourth electrode 125. To this end, the DC power supply unit 210 may be electrically connected to the first electrode 111, and the additionally DC power supply unit 220 may be electrically connected to the fourth electrode 125, and the second electrode 121 and the third electrode 115 may be electrically connected to each other.

The second electrode 121 and the third electrode 115 may be electrically connected to each other continuously or selectively, and polarities of the voltages supplied from the DC power supply unit 210 and the DC power supply unit 220 may be different from each other.

In this case, as described above, the powers of the DC power supply unit 210 and the DC power supply unit 220 may be individually or simultaneously controlled by one or a plurality of power supply control units 240.

The third electrode 115 may be branched into multiple line segments. At least some of the branched line segment of the third electrode 115 and the branched line segment of the first electrode 111 may be configured to be parallel to each other. The branched line segment of the third electrode 115 and the branched line segment of the first electrode 111 may be formed repeatedly with each other in the first surface 112a of the first dielectric substance 112.

The fourth electrode 125 may be branched into multiple line segments. At least some of the branched line segment of the fourth electrode 125 and the branched line segment of the second electrode 121 may be configured to be parallel to each other. The branched line segment of the fourth electrode 125 and the branched line segment of the second electrode 121 may be formed repeatedly with each other in the second surface 112b of the first dielectric substance 112.

On the plan view, the branched line segment of the first electrode and the branched line segment of the second electrode may be configured to match each other, and the branched line segment of the third electrode 115 and the branched line segment of the fourth electrode 125 may be configured to match each other.

When the positive voltage is applied to each of the first electrode 111 and the fourth electrode 125 by the DC power supply unit 210, and the cut-off switch 230 is closed, and each of the second electrode 121 and the third electrode 115 is grounded, the first dielectric substance 112 may be polarized.

Next, when the cut-off switch 230 is opened, and the voltage applied to the first electrode 111 and the fourth electrode 125 is cut off by the power supply control unit 240, a closed circuit in which the DC power supply unit 210, the basic dust collector 130, and the ground are connected in order becomes an open circuit by the opened cut-off switch 230.

In a structure in which the cut-off switch 230 is opened, even though the power is cut off, the electric charge stored in the first dielectric substance 112 may be retained by the opened cut-off switch 230. As a result, the electrical field E_{Pol} generated between two basic dust collectors 130 positioned to face each other may be retained for a long time even though the external power is cut off.

In this case, the electrical field E_{Pol} may be formed between the first electrode 111 and the second electrode 121 positioned to be adjacent to each other and to face each other by the polarization of the first dielectric substance 112 and the electrical field E_{Pol} may also be formed between the third electrode 115 and the fourth electrode 125 positioned to be adjacent to each other and to face each other, and electrical field distortion may be generated between the first electrode 111 and the third electrode 115, between the second electrode 121 and the fourth electrode 125, between the first electrode 111 and the second electrode 121, and between the third electrode 115 and the fourth electrode 125, which have the electrical potential from each other.

Through this, larger dielectrophoretic force may be obtained as compared with the exemplary embodiment of the present disclosure, in which only the first electrode 111 and the second electrode 121 are formed, and the dust in the dust-containing gas passing through the dust collection space 450 may be more effectively removed.

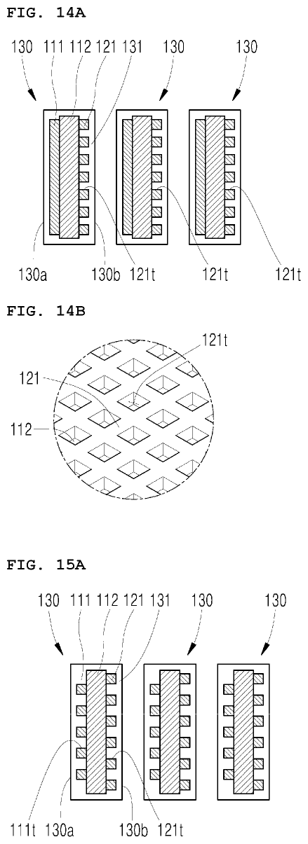

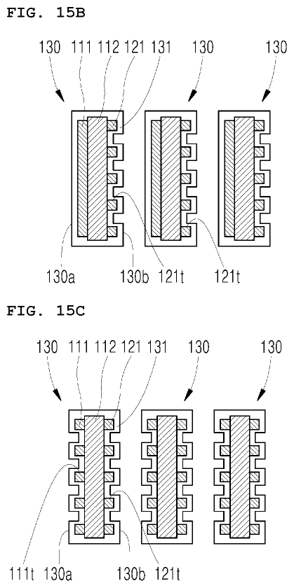

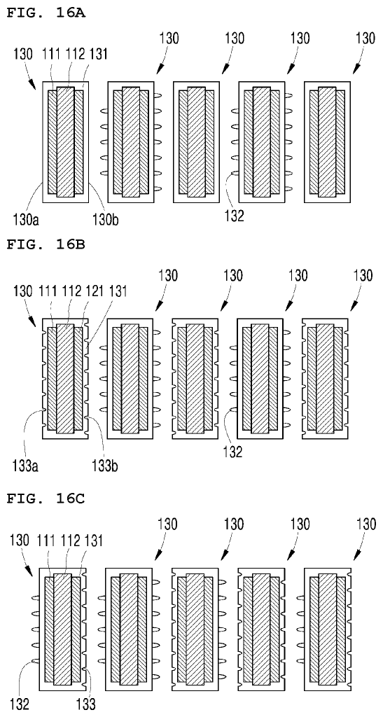

FIGS. 11A and 11B are diagrams illustrating an operation principle of the electrical dust collection apparatus 1 according to an exemplary embodiment of the present disclosure.

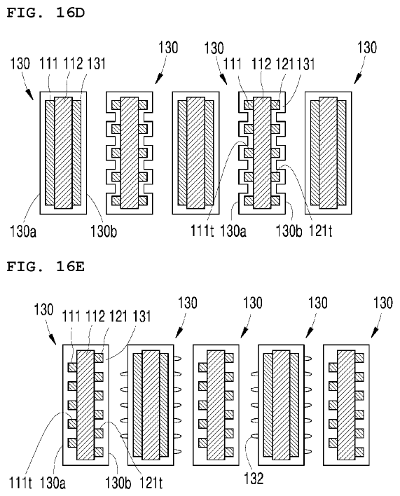

FIG. 12 is a diagram illustrating a case where the additional DC power supply unit 220 is further installed in the electrical dust collection apparatus 1 according to FIGS. 11A and 11B.

Each of FIGS. 13A, 13B, 13C, 13D, and 13E is a diagram illustrating a schematic shape of the basic dust collector 130 according to an exemplary embodiment of the present disclosure.

The electrical dust collection apparatus 1 may be configured to include a timer 250 according to an exemplary embodiment of the present disclosure.

The timer 250 is configured to measure a time when the power is supplied to or interrupted from the DC power supply unit 210 by the power supply control unit 240.

The operations of the power supply control unit 240 and the cut-off switch 230 may be individually or simultaneously controlled by one or a plurality of timers 250.

Specifically, as illustrated in FIG. 11A, one timer 250 may be connected to each of the power supply control unit 240 and the cut-off switch 230. Alternatively, any one timer may be connected to the power supply control unit 240, and the other one timer may be connected to the cut-off switch 230.

As described above, when the operation of the power supply control unit 240 or the cut-off switch 230 is time-controlled by the timer 250, the cut-off switch 230 is first opened, and then the power of the DC power supply unit 210 is interrupted to prevent the loss of the electric charges accumulated in the first electrode 111 and the second electrode 121.

When the additional DC power supply unit 220 is installed, the cut-off switch 230 may be positioned between the second electrode 121 and the additional DC power supply unit 220, and the powers of the DC power supply unit 210 and the additional DC power supply unit 220 may be individually or simultaneously controlled by one or a plurality of power supply control units 240 and timers 250.

In an exemplary embodiment, as illustrated in FIG. 12, the power supply control unit 240 may be connected to the DC power supply unit 210 and the additional DC power supply unit 220, and the timer 250 may be connected to the power supply control unit 240 and the cut-off switch 230.

Alternatively, unlike illustrated in FIG. 12, the electrical dust collection apparatus 1 may be configured to include two power supply control units (a first power supply control unit a second power supply control unit) and two timers (a first timer and a second timer). In this case, the first power supply control unit may be connected to the DC power supply unit 210 and the first timer, the second power supply control unit may be connected to the additional DC power supply unit 220 and the second timer, and the second timer may be connected to the cut-off switch 230.

In the electrical dust collection apparatus 1 according to an exemplary embodiment of the present disclosure, the basic dust collector 130 may be configured to include the first protrusion 132 and/or the first groove 133.

The first protrusion 132 is configured in a form of being projected outward from the surface of the external insulator 131.

The first protrusion 132 may be made by an insulator, but the material thereof is not limited. The first protrusion 132 may be made of the same material as the external insulator 131. The first protrusion 132 may be configured integrally with the external insulator 131.

The first protrusion 132 is projected toward another adjacent basic dust collector 130. The first protrusion 132 may be formed on any one surface of the basic dust collector 130 or formed on both surfaces of the basic dust collector 130.

A plurality of first protrusions 132 may all be formed in the same shape and size or formed indifferent shapes or sizes. Respective first protrusions 132 may be configured in various forms including a hemisphere form, a cylindrical form, a prism form, a cone form, a tapered form, a wedge form, etc.

In the basic dust collector 130, the plurality of first protrusions 132 may be provided and the respective first protrusion 132 may be spaced apart from each other. In this case, the respective first protrusions 132 may be arranged along the row and the column, and spaced apart from each other at a predetermined interval.

The first protrusions 132 may be connected to each other, and in this case, the first protrusion 132 may be configured in the grid form when viewed on any one surface of the basic dust collector 130.

The first groove 133 is configured in a concave groove form on the surface of the external insulator 131.

The first groove 133 may be formed on any one surface of the basic dust collector 130 or formed on both surfaces of the basic dust collector 130.

The first groove 133 may be configured in various forms including the hemisphere form, the cylindrical form, the prism form, the cone form, the tapered form, the wedge form, etc.

In the basic dust collector 130, a plurality of first grooves 133 may be provided. The plurality of first grooves 133 may all be formed in the same shape and size or formed in different shapes or sizes. When the plurality of first grooves 133 is provided, the respective first grooves 133 may be spaced apart from each other. In this case, the respective first grooves 133 may be arranged along the row and the column, and spaced apart from each other at a predetermined interval.

The first grooves 133 may be connected to each other, and in this case, the first groove 133 may be configured in the grid form when viewed on any one surface of the basic dust collector 130.

The basic dust collector 130 is configured to include a 1-1^{st} surface 130a and a 2-1^{st} surface 130b facing each other. The 1-1^{st} surface 130a is a surface at a side where the first electrode 111 is formed in the basic dust collector 130, and the 2-1^{st} surface 130b as an opposite surface to the 1-1^{st} surface 130a is a surface at a side where the second electrode 121 is formed in the basic dust collector 130.

In the electrical dust collection apparatus 1 according to an exemplary embodiment, the first protrusion 132 may be formed on the 1-1^{st} surface 130a or the 2-1^{st} surface 130b (see FIG. 13A).

In the electrical dust collection apparatus 1 according to another exemplary embodiment, the first protrusion 132 may be formed on the 1-1^{st} surface 130a and the 2-1^{st} surface 130b (see FIG. 13B).

In the electrical dust collection apparatus 1 according to yet another exemplary embodiment, the first groove 133 may be formed on the 1-1^{st} surface 130a or the 2-1^{st} surface 130b (see FIG. 13C).

In the electrical dust collection apparatus 1 according to still yet another exemplary embodiment, the first groove 133 may be formed on the 1-1^{st} surface 130a and the 2-1^{st} surface 130b (see FIG. 13D).

In the electrical dust collection apparatus 1 according to further yet another exemplary embodiment, the first protrusion 132 may be formed on any one surface of the 1-1^{st} surface 130a and the 2-1^{st} surface 130b and the first groove 133 may be formed on the other surface of the 1-1^{st} surface 130a and the 2-1^{st} surface 130b (see FIG. 13E).

In the electrical dust collection apparatus 1 according to an exemplary embodiment of the present disclosure, the first protrusion 132 or the first groove 133 formed on the surface of the basic dust collector 130 concentrates and distorts the internal electrical field Eᵢₙ generated between the basic dust collectors 130 to increase the dust collection efficiency for the dust in the dust-containing gas.

That is, when the internal electrical field Eᵢₙ is generated between the basic dust collectors 130, a point at which the first protrusion 132 is formed is positioned to be closer to the adjust basic dust collector 130 than to a point at which the first protrusion 132 is not formed, so the stronger electrical field may be generated and a point at which the first groove 133 is formed is positioned to be further from the adjacent basic dust collector 30 than to a point where the first groove 133 is not formed, so a weaker electrical strength may be generated. In this case, the internal electrical field Eᵢₙ between two basic dust collectors 130 is concentrated on a portion where the first electrode 132 is positioned or the first groove 133 not is formed, and the intensity of the electrical field varies depending on the location and develops non-uniformly.

The concentration and distortion phenomenon of the internal electrical field Eᵢₙ by the first protrusion 132 and the first groove 133 may grant the Coulomb's force and the dielectrophoretic force to the dust in the dust-containing gas to increase the dust collection efficiency. Further, the shape itself of the first protrusion 132 may serve as a filter fiber and serve to increase a dust collection area to further increase the dust collection efficiency of the electrical dust collector.

In the exemplary embodiment of the present disclosure, the first protrusion 132 may be divided into a 1-1^{st} protrusion 132a and a 1-2^{nd} protrusion 132b, and the 1-1^{st} protrusion 132a is a protrusion formed on the 1-1^{st} surface 130a and the 1-2^{nd} protrusion 132b is a protrusion formed on the 2-1^{st} surface 130b. Further, the first groove 133 may be divided into a 1-1^{st} groove 133a and a 1-2^{nd} groove 133b, and the 1-1^{st} groove 133a is a groove formed on the 1-1^{st} surface 130a and the 1-2^{nd} groove 133b is a groove formed on the 2-1^{st} surface 130b.

In the electrical dust collection apparatus 1 according to an exemplary embodiment, the 1-1^{st} protrusion 132a provided in any one basic dust collector 130 and the 1-2^{nd} protrusion 132b provided in the other one basic dust collector 130 may be arranged to be dislocated with each other (see FIG. 13B).

In the electrical dust collection apparatus 1 according to another exemplary embodiment, when the first protrusion 132 is formed on the 1-1^{st} surface 130a and the first groove 133 is formed on the 2-1^{st} surface 130b, the first protrusion 132 provided in any one basic dust collector 130 and the first groove 133 provided in the other one basic dust collector 130 may be arranged to be dislocated with each other (see FIG. 13E).

In the electrical dust collection apparatus 1 according to yet another exemplary embodiment, the 1-1^{st} groove 133a provided in any one basic dust collector 130 and the 1-2^{nd} groove 133b provided in the other one basic dust collector 130 may be arranged to be dislocated with each other (see FIG. 13D).

As described above the first protrusion 132 or the first groove 133 formed in two basic dust collectors 130 positioned to face each other induces the concentration and distortion of the electrical field to enhance the dust collection performance, and in this case, a dislocation arrangement of the first electrode 132 and the first groove 133 positioned to face each other makes the electrical field be non-uniformly formed frequently in the dust collection space 450 to further enhance the dust collection performance.

Meanwhile, the internal electrical field Eᵢₙ non-uniformly developed by the first electrode 132 and the first groove 133 is retained even in the state in which the power of the DC power supply unit 210 is cut off, the power consumption may be minimized and dust collection in the dust-containing gas may be effectively achieved.

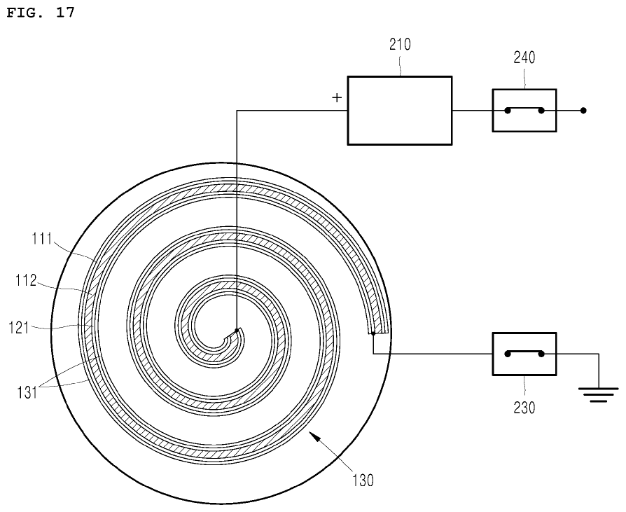

FIG. 14A is a diagram schematically illustrating the shape of the basic dust collector 130 according to an exemplary embodiment of the present disclosure and FIG. 14B is a partial perspective view schematically illustrating a state of a second electrode formed at any one side of the basic dust collector 130 according to an exemplary embodiment of the present disclosure.

Each of FIGS. 15A, 15B, and 15C is a diagram schematically illustrating the basic dust collector 130 according to an exemplary embodiment of the present disclosure.

Each of FIGS. 16A, 16B, 16C, 16D, and 16E is a diagram illustrating a state in which the basic dust collector 130 is arranged.

In the electrical dust collection apparatus 1 according to an exemplary embodiment of the present disclosure, the first region portion lilt may be a through-hole through which the first electrode 111 passes and the second region portion 121t may be a through-hole which the second electrode 121 passes. Likewise, in the exemplary embodiment of the present disclosure, the first electrode 111 may be configured to include a plurality of first through-holes lilt and the second electrode 121 may also include a plurality of second through-holes 121t.

In the first electrode 111, the plurality of first through-holes lilt may be repeatedly formed while constituting the row and the column. As a result, when viewed on any one surface of the basic dust collector 130, the first electrode 11 may be configured in the grid form. Similarly, in the second electrode 121, the plurality of second through-holes 121t may be repeatedly formed while constituting the row and the column, and as a result, the second electrode 121 may be configured in the grid form when viewed on any one surface of the basic dust collector 130 (see FIG. 14B).

The external insulator may be configured to be connected to the first dielectric substance 112 by penetrating the first through-hole lilt of the first electrode 111, and further, the external insulator 131 may be configured to be connected to the first dielectric substance 112 by penetrating the second through-hole 121t of the second electrode 121.

In an exemplary embodiment, the external surface of the external insulator 131 may be configured to be flat (see FIG. 15A).

In another exemplary embodiment, the outer surface of the external insulator 131 may be configured in a form in which the protrusion and the groove are repeated according to the shapes of the first electrode 111 and the second electrode 121 (see FIGS. 15B and 15C).

The first through-hole lilt and the second through-hole 121t formed in the first electrode 111 and the second electrode 121 may induce the concentration and distortion phenomenon of the internal electrical field Eᵢₙ formed between two basic dust collectors 130 facing each other like the first protrusion 132 and the first groove 133. That is, the internal electrical field Eᵢₙ may be formed more strongly at the point where the first electrode 111 is positioned than the first through-hole lilt is formed, and the internal electrical field Eᵢₙ may be formed more strongly at the point where the second electrode 121 is positioned than the second through-hole 121t is formed Further, since the electrical field is strongly distorted at an edge portion (edge effect), the dielectrophoretic force may also be maximized at an edge at which the first electrode 111 contacts the first through-hole lilt and an edge at which the second electrode 121 contacts the second through-hole 121t due to a strong electrical field distortion effect.

Hereinabove, all of the first protrusion 132, the first groove 133, the first through-hole lilt, and the second through-hole 121t described above are utilized as physical devices that induce the concentration and distortion phenomenon of the internal electrical field Eᵢₙ developed in two adjacent basic dust collectors 130, and the dust collection performance suing the dielectrophoretic force may be enhanced through the utilized physical device.

The respective physical devices may be mixedly used. For example, the 1-1^{st} protrusion 132a and the second groove 133b may be simultaneously used in one basic dust collector 130, and in this case, the first electrode 111 and the second electrode 121 may also include the first through-hole lilt and the second through-hole 121t, respectively.

Further, the electrical dust collection apparatus 1 according to an exemplary embodiment of the present disclosure may be configured by a combination of a plurality of basic dust collectors 130 included in different physical devices. For example, an object of the present disclosure may also be implemented by arranging the basic dust collector 130 including the first protrusion 132 and the basic dust collector 130 not including even any one physical device to cross each other and to be spaced apart from each other (see FIG. 16A). Besides, it is possible to arrange a plurality of basic dust collectors 130 including different physical devices of various combinations to cross and to be spaced apart from each other (see FIGS. 16B and 16C), and in this case, the first electrode 111 and the second electrode 121 may also include the first through-hole lilt and the second through-hole 121t, respectively (see FIGS. 16D and 16E).

Each of FIGS. 17 and 18 is a diagram illustrating a schematic shape of the basic dust collector 130 in the electrical dust collection apparatus 1 according to an exemplary embodiment of the present disclosure.

In the exemplary embodiment of the present disclosure, the basic dust collector 130 may be configured in a roll form. That is, one basic dust collector 130 may be configured to be repeatedly wound.

When the basic dust collector 130 is wound in the roll form, the 1-1^{st} surface 130a and the 2-1^{st} surface 130b which are the outer surfaces of the basic dust collector 130 may be spaced apart from each other, the space may be provided between the 1-1^{st} surface 130a and the 2-1^{st} surface 130b, and the dust-containing gas may be collected while passing through the space.

The basic dust collector 130 is configured in the roll form, and as a result, even though a plurality of basic dust collectors distinguished from each other is not provided, an electrical dust collection apparatus 1 may be formed which includes only one basic dust collector 130 configured integrally to sufficiently secure the dust collection capacity, and an electrical dust collection apparatus 1 may be formed, which is easily electrically connected to the DC power supply unit 210.

Further, according to the exemplary embodiment of the present disclosure, one basic dust collector 130 is configured in the roll form to easily form the space between the 1-1^{st} surface 130a and the 2-1^{st} surface 130b of the basic dust collector.

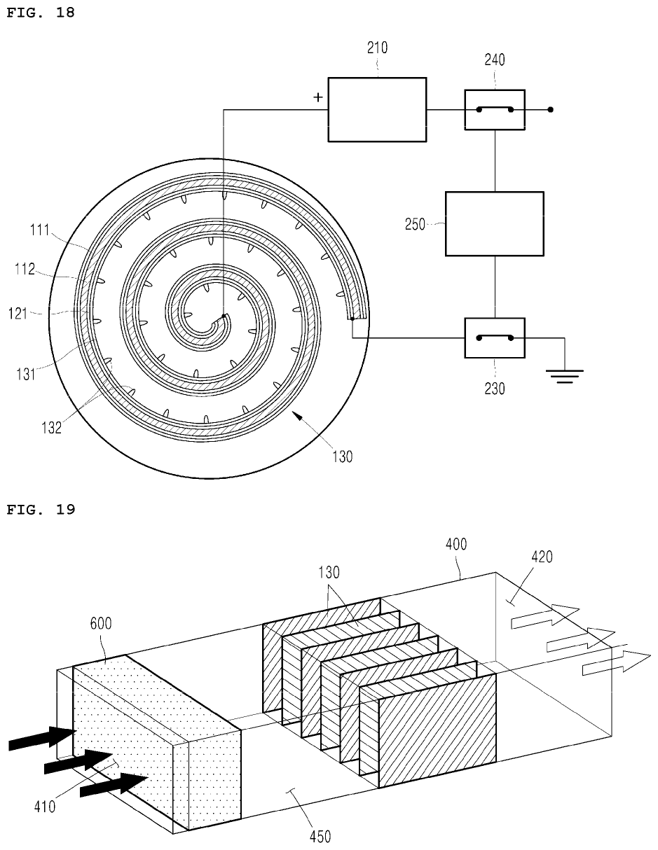

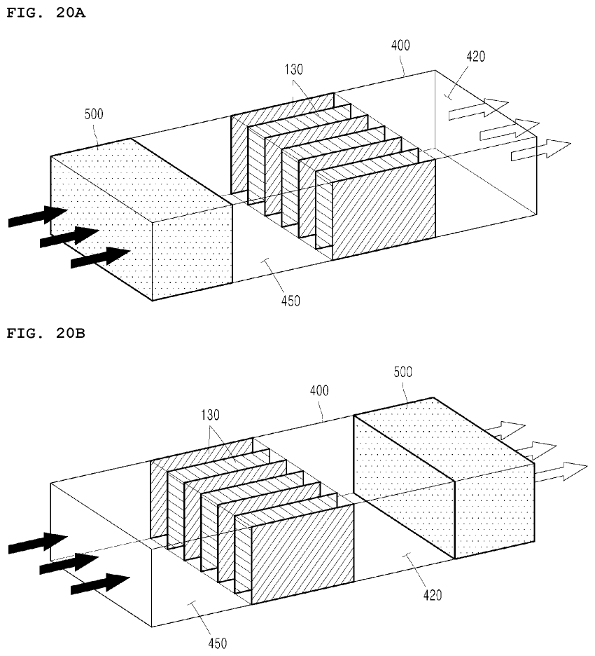

FIG. 19 is a diagram schematically illustrating a state in which a filter 600 is provided in a housing 400 of the electrical dust collection apparatus 1 according to an exemplary embodiment of the present disclosure. In FIG. 19, a form in which the filter 600 is disposed in the inlet 410 is illustrated, but the filter may also be disposed in the outlet 420.

The electrical dust collection apparatus 1 according to an exemplary embodiment of the present disclosure may be configured to include the filter 600. The filter 600 may be configured to be disposed in the inlet 410 and/or the outlet 420 to remove the dust from the dust-containing gas.

The filter 600 may be formed in a form such as a filter net. The filter 600 may be configured in a form such as a general pre filter, but is not limited thereto.

The filter 600 disposed at the inlet 410 may be configured a preprocessing pre filter form, and the filter disposed at the outlet 420 may be configured in a dust collection filter (HEPA filter) form.

The filter 600 disposed at the inlet 410 is configured to previously remove dust having a comparatively large size from the dust-containing gas introduced into the inlet 410, and more effectively remove the dust of the dust-containing gas from the dust collection space 450.

When the filter 600 is disposed in the outlet 420, the dust introduced into the filter is first processed by the electrical dust collection apparatus 1 to increase a use period of the filter.

Each of FIGS. 20A and 20B is a diagram schematically illustrating a state in which a particle charging unit 500 is provided in the electrical dust collection apparatus 1 according to an exemplary embodiment of the present disclosure.

As illustrated in FIGS. 20A and 20B, the electrical dust collection apparatus 1 of the present disclosure may further include the particle charging unit 500 which is coupled to the inlet 410 or the outlet 420 of the housing 400, and ionizes gas and electrically charges surrounding dust. FIG. 20A is a diagram illustrating a state in which the particle charging unit 500 is formed at the inlet 410 of the housing 400 and FIG. 20B is a diagram illustrating a state in which the particle charging unit 500 is formed at the outlet 420 of the housing 400.

The particle charging unit 500 may include an internal space and the electrical field may be generated in the internal space of the particle charging unit 500. In addition, a dust particle of the dust-containing gas passing through the particle charging unit 500 may be charged. As the particle charging unit 500, a corona discharge using particle charging device, a flame using particle charging device, a light source using particle charging device, a friction electrification using particle charging device, etc., may be used.

As illustrated in FIG. 20A, when the particle charging unit 500 is coupled to the inlet 410 of the housing 400, the dust particle of the dust-containing gas passing through the particle charging unit 500 is charged and passes between the respective dust collectors to increase an electrical mobility for the electrical field E_{Pol}, thereby increasing the dust collection efficiency.

In addition, as illustrated in FIG. 20B, a case where the particle charging unit 500 is coupled to the outlet 420 of the housing 400 may be a case where the particle charging unit 500 is used for dust collection of a closed space. Gas after dust collection, which is the dust-containing gas passing through each dust collector may be ionized by passing the particle charging unit 500, and in this case, a generated negative ion or positive ion may be collected, and then released to the closed space jointly with the gas. The dust suspended to the closed space may be electrically charged while moving along an air current jointly with the released negative ion or positive ion, and when the dust is introduced into the electrical dust collection apparatus 1 of the present disclosure through the inlet of the housing 400, the dust may be collected with a high probability.

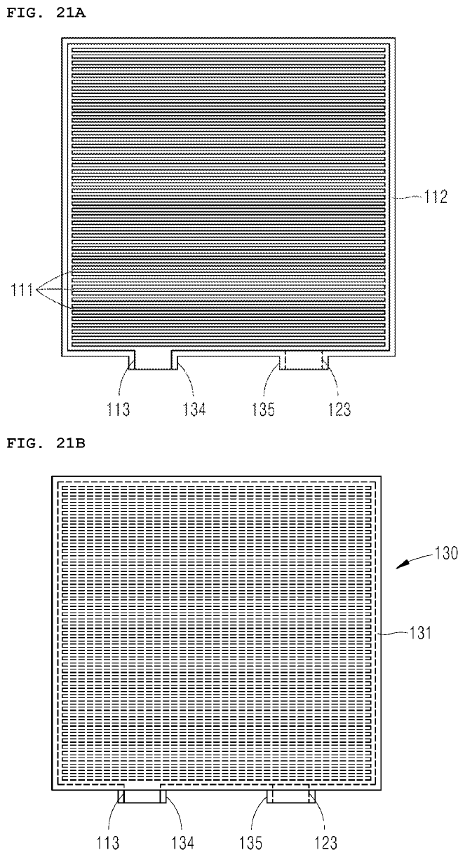

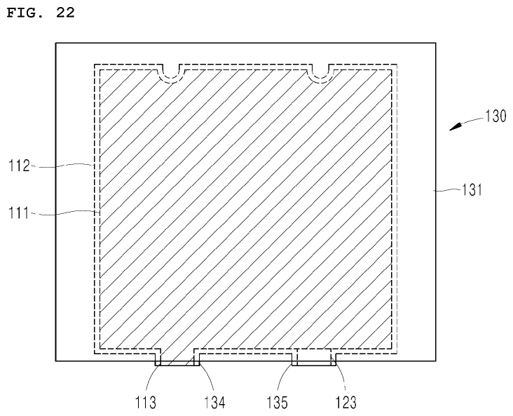

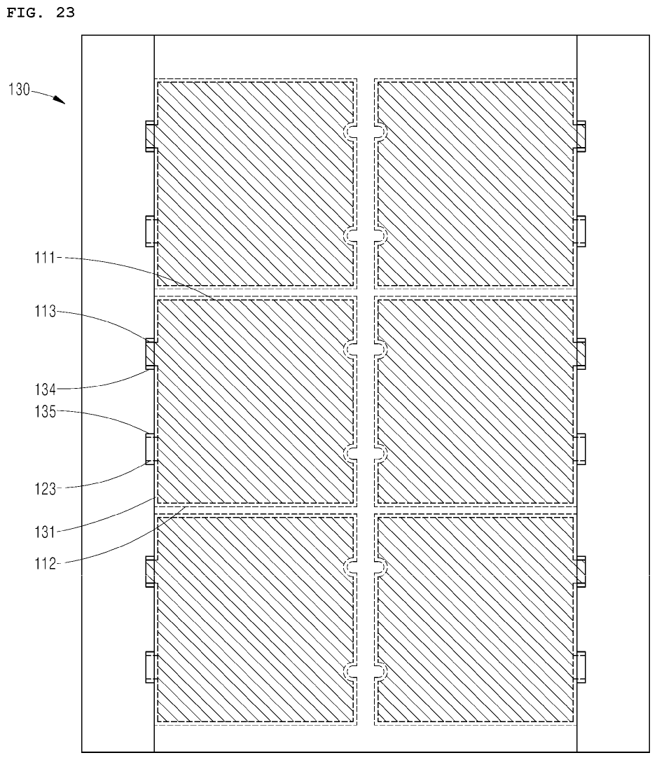

FIGS. 21A and 21B are diagrams schematically illustrating a state in which a terminal connected to an electrode is formed in the basic dust collector 130 according to an exemplary embodiment of the present disclosure. FIG. 21A illustrates a state before the external insulator 131 is formed and FIG. 21B is a state after the external insulator 131 is formed.

Each of FIGS. 22 and 23 is a diagram schematically illustrating a state in which the external insulator 131 is laminated in the basic dust collector 130.

The basic dust collector 130 may be configured to include terminals 113 and 123 connected to the electrodes 111 and 121. The terminals 113 and 123 form parts in which the basic dust collector 130 is electrically connected to another component.

The terminals 113 and 123 may not be covered with the external insulator 131. The terminals 113 and 123 may protrude to the outside of the region of the external insulator 131.

In the exemplary embodiment of the present disclosure, the terminal may be divided into a first terminal 113 and a second terminal 123.

The first electrode 113 is connected to the first electrode 111 on the first surface 112a of the first dielectric substance 112 and the second terminal 123 is connected to the second electrode 121 on the second surface 112b of the first dielectric substance 112. The first terminal 113 and the second terminal 123 may be formed at the end portion of the basic dust collector 130. The first terminal 113 and the second terminal 123 may be configured to protrude outward from the edge of the basic dust collector 130.

The first terminal 113 may be configured integrally with the first electrode 111 and the second terminal 123 may be configured integrally with the second electrode 121.

The first dielectric substance 112 may be configured to include a first protruding portion 134 and a second protruding portion 135. Each of the first protruding portion 134 and the second protruding portion 135 may be configured to protrude outward from the edge of the first dielectric substance 112. The first terminal 113 is formed in the first protruding portion 134 and the second terminal 123 is formed in the second protruding portion 135.

In the basic dust collector 130, the external insulator 131 may be coupled to the outsides of the first dielectric substance 112, the first electrode 111, and the second electrode 121 without covering the first terminal 113 and the second terminal 123.

When the external insulator 131 is formed by laminating, at least a part of the first terminal 113 and the second terminal 123 may be configured to be not covered by the external insulator 131, but exposed to the external insulator 131.

As such, the terminal (the first terminal 113 and the second terminal 123) is configured to be exposed to easily achieve electrical connection of the basic dust collector 130 and application of the external power to the basic dust collector 130.

FIG. 22 is a diagram schematically illustrating a state in which the external insulator 131 is laminated in the basic dust collector 130.

As illustrated in FIG. 22, the external insulator 131 may be laminated to the first dielectric substance 112, the first electrode 111, and the second electrode 121 so as to cover both the first electrode and the second electrode while shielding at least a part (e.g., a length of approximately 1 to 2 mm) of the first terminal 113 and the second terminal 123.

Thereafter, the external insulator 131 is cut along a predetermined cutting line (e.g., a periphery of the first dielectric substance 112) to complete the basic dust collector 130.

FIG. 23 is a diagram schematically illustrating a state in which the external insulator 131 is laminated in the basic dust collector 130 in a state before the basic dust collector 130 is rolled in the roll form in manufacturing the basic roll-form basic dust collector 130.

As illustrated in FIG. 23, the external insulator 131 may be laminated to the first dielectric substance 112, the first electrode 111, and the second electrode 121 so as to cover both the first electrode 111 and the second electrode 121 while shielding at least a part (e.g., a length of approximately 1 to 2 mm) of the first terminal 113 and the second terminal 123.

As described above, when the basic dust collector 130 is configured in a predetermined shape (e.g., a square, a circle, or other polygons), only the first terminal 113 and the second terminal 123 parts are configured to further protrude outward, and as a result, when the external insulator 131 configured in the film form is coupled to the first dielectric substance 112 by the laminating, a basic dust collector 130 may be formed in which all electrodes 111 and 121 are easily completely shielded and easily electrically connected to the outside.

Hereinabove, a specific embodiment of the present disclosure is described and illustrated, but the present disclosure is not limited to the disclosed embodiment, and it may be appreciated by those skilled in the art that the embodiment can be variously modified and transformed to another specific embodiment without departing from the spirit and the scope of the present disclosure. Therefore, the scope of the present disclosure will not be defined by the described embodiment, but defined by the technical spirit disclosed in the claims.

What is claimed is:

1. An ultra low power electrical dust collection apparatus comprising:
a housing including a dust collection space provided inside, an inlet through which dust-containing gas is introduced, and an outlet through gas from which dust is removed is released;
a basic dust collector including a first dielectric substance positioned in the dust collection space, and having a first surface and a second surface facing each other, a conductive first electrode formed on the first surface, a conductive second electrode formed on the second surface, and an external insulator made of an insulator covering the first electrode and the second electrode;
a DC power supply unit applying voltage to the basic dust collector so that an electrical potential is formed between the first electrode and the second electrode;
a cut-off switch connected between the basic dust collector and the DC power supply unit; and
a power supply control unit controlling power supplying to the DC power supply unit,
wherein the basic dust collector is provided with a plural number or configured in a roll form,
the basic dust collector includes a first region portion in which an electrode is not formed on the first surface, and the first electrode and the first region portion are repeated along the first surface, and
the power supplied to the DC power supply unit is interrupted and the cut-off switch is opened by the power supply control unit in a state in which the electrical potential is formed, and dust is removed from the dust-containing gas by an electrical field formed by polarization of the first dielectric substance due to the electrical potential.

2. The ultra low power electrical dust collection apparatus of claim 1, wherein the basic dust collector includes a second region portion in which the electrode is not formed on the second surface, and the second electrode and the second region portion are repeated along the second surface.

3. The ultra low power electrical dust collection apparatus of claim 1, wherein the first electrode is branched into multiple line segments, and at least some of respective line segments of the first electrode are disposed in line with each other.

4. The ultra low power electrical dust collection apparatus of claim 2, wherein the first electrode is branched into multiple line segments, and at least some of the respective line segments of the first electrode are disposed in line with each other, and
the second electrode is branched into multiple line segments, and at least some of the respective line segments of the second electrode are disposed in line with each other.

5. The ultra low power electrical dust collection apparatus of claim 4, wherein at least some of the branched line segment of the first electrode and the branched line segment of the second electrode are configured to be parallel to each other, and
the branched line segment of the first electrode and the branched line segment of the second electrode are configured to be dislocated with each other, on a plan view.

6. The ultra low power electrical dust collection apparatus of claim 1, wherein the basic dust collector includes a conductive third electrode formed to be spaced apart from the first electrode on the first surface and a conductive fourth electrode formed to be spaced apart from the second electrode on the second surface,
the external insulator is configured to cover the third electrode and the fourth electrode, and
the DC power supply unit is configured to apply voltage to the basic dust collector so that the electrical potential is formed between the third electrode and the fourth electrode.

7. The ultra low power electrical dust collection apparatus of claim 6, wherein each of the first electrode and the third electrode is branched into multiple line segments, and
at least some of the branched line segment of the first electrode and the branched line segment of the second electrode are configured to be parallel to each other.

8. The ultra low power electrical dust collection apparatus of claim 7, wherein each of the second electrode and the fourth electrode is branched into multiple line segments, and
at least some of the branched line segment of the second electrode and the branched line segment of the fourth electrode are configured to be parallel to each other.

9. The ultra low power electrical dust collection apparatus of claim 8, wherein on the plan view, the branched line segment of the first electrode and the branched line segment of the second electrode are configured to match each other, and the branched line segment of the third electrode and the branched line segment of the fourth electrode are configured to match each other.

10. The ultra low power electrical dust collection apparatus of claim 1, wherein the first region portion is a through-hole penetrating the first electrode.

11. The ultra low power electrical dust collection apparatus of claim 2, wherein the first region portion is a through-hole penetrating the first electrode and the second region portion is a through-hole penetrating the second electrode.

12. The ultra low power electrical dust collection apparatus of claim 1, wherein the external insulator includes a plurality of protrusions which protrudes to any one side or both sides.

13. The ultra low power electrical dust collection apparatus of claim 1, further comprising:
a filter disposed at the inlet or the outlet and removing the dust from the dust-containing gas.

14. The ultra low power electrical dust collection apparatus of claim 1, further comprising:
a particle charging unit disposed at the inlet or the outlet, and ionizing the gas and electrically charging surrounding dust.

15. An ultra low power electrical dust collection apparatus comprising:
a housing including a dust collection space provided inside, an inlet through which dust-containing gas is introduced, and an outlet through gas from which dust is removed is released;
a basic dust collector including a first dielectric substance positioned in the dust collection space, and having a first surface and a second surface facing each other, a conductive first electrode formed on the first surface, a conductive second electrode formed on the second surface, and an external insulator made of an insulator covering the first electrode and the second electrode;
a DC power supply unit applying voltage to the basic dust collector so that an electrical potential is formed between the first electrode and the second electrode;
a cut-off switch connected between the basic dust collector and the DC power supply unit; and
a power supply control unit controlling power supplying to the DC power supply unit,
where the basic dust collector is provided with a plural number or configured in a roll form,
a plurality of first protrusions which protrudes on an outer surface of the external insulator is provided, and
the power supplied to the DC power supply unit is interrupted and the cut-off switch is opened by the power supply control unit in a state in which the electrical potential is formed, and dust is removed from the dust-containing gas by an electrical field formed by polarization of the first dielectric substance due to the electrical potential.

16. The ultra low power electrical dust collection apparatus of claim 15, wherein the basic dust collector includes a 1-1^{st} surface which is a surface where the first electrode is formed and a 2-1^{st} surface which is a surface where the second electrode is formed, and
the first protrusion is formed in at least any one of the 1-1^{st} surface and the 2-1^{st} surface.

17. The ultra low power electrical dust collection apparatus of claim 15, wherein the first protrusion is divided into a 1-1^{st} protrusion positioned at a portion where the first electrode is formed and a 1-2^{nd} protrusion positioned at a portion where the second electrode is formed, and
the 1-1^{st} protrusion and the 1-2^{nd} protrusion are disposed to be dislocated with each other on a plan view.

18. The ultra low power electrical dust collection apparatus of claim 15, further comprising:
a filter disposed at the inlet or the outlet and removing the dust from the dust-containing gas.

19. The ultra low power electrical dust collection apparatus of claim 15, further comprising:
a particle charging unit disposed at the inlet or the outlet, and ionizing the gas and electrically charging surrounding dust.
